(19) United States
(12) Patent Application Publication
(10) Pub. No.: US 2018/0234426 A1
(43) Pub. Date: Aug. 16, 2018

(54) AUTHORIZATION SERVER, AUTHORIZATION METHOD AND NON-TRANSITORY COMPUTER READABLE MEDIUM THEREOF

(71) Applicant: Institute For Information Industry, Taipei (TW)

(72) Inventors: You-Lian HUANG, Taoyuan City (TW); Hsin-I LAI, Taipei City (TW)

(21) Appl. No.: 15/471,172

(22) Filed: Mar. 28, 2017

(30) Foreign Application Priority Data
Feb. 15, 2017 (TW) 106104890

(51) Int. Cl. H04L 29/06; H04L 9/32; H04L 9/08

(52) U.S. Cl. CPC H04L 63/101; H04L 9/0861; H04L 9/3242; H04L 63/06

(57) ABSTRACT

An authorization server, an authorization method and a non-transitory computer readable medium thereof are provided. The authorization server calculates an i^{th} hash value from the first key and the (i−1)^{th} hash value with the hash function, where i corresponds to an i^{th} time interval. After receiving an authorization request message carrying a user identification (ID) from a user device, the authorization server generates an i^{th} access token by encrypting the i^{th} hash value, the user ID and the permission value corresponding to the user ID with the second key, and transmits the i^{th} access token to the user device.

### PRIORITY

This application claims priority to Taiwan Patent Application No. 106104890 filed on Feb. 15, 2017, which is hereby incorporated by reference in its entirety.

### FIELD

The present invention relates to an authorization server, an authorization method for an authorization server and a non-transitory computer readable medium thereof. More particularly, the authorization server of the present invention generates a plurality of hash values that correspond to a plurality of continuous time intervals according to the irreversibility of a one-way hash function. Therefore, during each time interval, an access token can be generated by encrypting user-related information together with the hash value corresponding to the time interval and then provided for later use by a user to obtain services.

### BACKGROUND

In conventional application programming interface (API) authorization programs, an authorization server generates an access token immediately after the registration and login of a user (i.e., after the user is authorized) so that the user can use the access token to obtain related resources and services within a valid time interval.

The authorization server generates the access token generally by using random numbers or an encryption function. When the random numbers are used to generates the access token, the authorization server needs a large storage space to store access tokens of all users (which include currently valid access tokens and invalid access tokens) so as to read the access tokens from a database of a storage device (e.g., a memory, a hard disk or a connected network storage device) for verification during the authorization and trace to determine whether the access token carried in a packet that fails the authorization is an invalid access token, thereby blocking malicious attempts of illegal users.

When the database of the hard disk or the connected network storage device is used to store the access tokens of all the users, the authorization server needs to perform a lot of input/output (I/O) actions in response to the calling of a lot of users, thereby excessively slowing the response time due to the restriction on accessing speeds of the hard disk and the network. Moreover, when the memory of each of authorization servers is used as the storage device to separately store the access tokens of the users, integration needs to be additionally performed among the access tokens stored in these authorization servers for consistency so as to prevent data loss when one of the authorization servers shuts down.

On the other hand, when the encryption function is used to generate the access token, the authorization server only needs to encrypt the user data to generate the access token and does not need to store the access token of the user. However, since the authorization server does not store any authorization data that varies according to the time interval (e.g., the access tokens of the past), the authorization server cannot trace to determine the legality of the packet and thereby cannot block the malicious attempts of the illegal users.

Accordingly, an urgent need exists in the art to provide an authorization mechanism, which can trace to determine the legality of the packet without the need of storing the access tokens of the users.

### SUMMARY

An objective of certain embodiments is to provide an authorization mechanism, which generates a particular hash value related to a time interval as one of authorization data according to the irreversibility of a one-way hash function, and generates an access token by encrypting the hash value corresponding to the current time interval, a user identification (ID) and a user permission value. In this way, the authorization mechanism does not need to store the access token of the user for later authorization and is capable of tracing to determine the legality of the packet by decrypting the access token to obtain the particular hash value associated with the time interval.

The disclosure includes an authorization server, which comprises a memory, a network interface and a processor. The memory is configured to store a first key and a second key. The processor is electrically connected to the memory and the network interface and is configured to calculate an i^{th} hash value from the first key and an (i−1)^{th} hash value stored in the memory according to a hash function and store the i^{th} hash value into the memory. i corresponds to an i^{th} time interval and is a positive integer larger than 2. The processor is further configured to execute the following operations: receiving an authorization request message carrying a user identification (ID) of a user device from the user device via the network interface; generating an i^{th} access token by encrypting the i^{th} hash value, the user ID and a permission value corresponding to the user ID with the second key; and transmitting the i^{th} access token to the user device via the network interface.

The disclosure also includes an authorization method for an authorization server. The authorization server comprises a memory, a network interface and a processor. The memory stores a first key and a second key. The authorization method is executed by the processor and comprises the following steps of: calculating an i^{th} hash value from the first key and an (i−1)^{th} hash value stored in the memory according to a hash function, and storing the i^{th} hash value into the memory, wherein i corresponds to an i^{th} time interval and is a positive integer larger than 2; receiving an authorization request message carrying a user identification (ID) of a user device from the user device via the network interface; generating an i^{th} access token by encrypting the i^{th} hash value, the user ID and a permission value corresponding to the user ID with the second key; and transmitting the i^{th} access token to the user device via the network interface.

The disclosure further includes a non-transitory computer readable medium. The non-transitory computer readable medium stores a computer program comprising a plurality of codes. When the computer program is loaded into an authorization server having a processor, the codes are executed by the processor to accomplish an authorization method. The authorization server comprises a memory, a network interface and the processor, and the memory stores a first key and a second key. The authorization method comprises the following steps: calculating an i^{th} hash value from the first key and an (i−1)^{th} hash value stored in the memory according to a hash function, and storing the i^{th} hash value into the memory, wherein i corresponds to an i^{th} time interval and is a positive integer larger than 2; receiving an authorization request message carrying a user identification (ID) of a user device from the user device via the network interface; generating an i^{th} access token by encrypting the i^{th} hash value, the user ID and a permission value corresponding to the user ID with the second key; and transmitting the i^{th} access token to the user device via the network interface.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an authorization server 1 of the present invention;

FIG. 1B depicts signal transmission between the authorization server 1 and a user device 3;

FIG. 1C depicts a way of generating an access token according to the present invention;

FIG. 2 depicts signal transmission between the authorization server 1 and a user device 5;

FIG. 3 depicts signal transmission among the authorization server 1, a service resource server 7 and the user device 5; and

FIG. 4 is a flowchart diagram of an authorization method of the present invention.

### DETAILED DESCRIPTION

In the following description, the present invention will be explained with reference to example embodiments thereof. The present invention can be embodied, for example, as an authorization server, an authorization method for an authorization server and a non-transitory computer readable medium thereof. It shall be appreciated that, these example embodiments are not intended to limit the present invention to any particular examples, embodimenrts, environment, applications or implementations described in these example embodiments. Therefore, description of these example embodiments is only for purpose of illustration rather than to limit the present invention, and the scope claimed in the invention shall be governed by the claims.

In the following example embodiments and the attached drawings, elements unrelated to the present invention are omitted from depiction; and dimensional relationships among individual elements in the attached drawings are illustrated only for ease of understanding, but not to limit the actual scale.

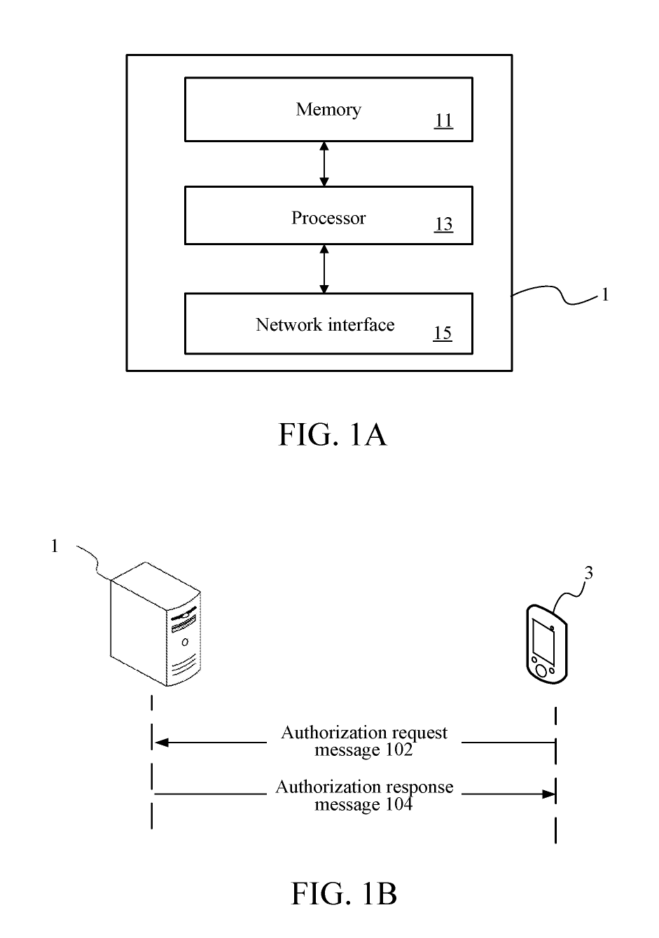

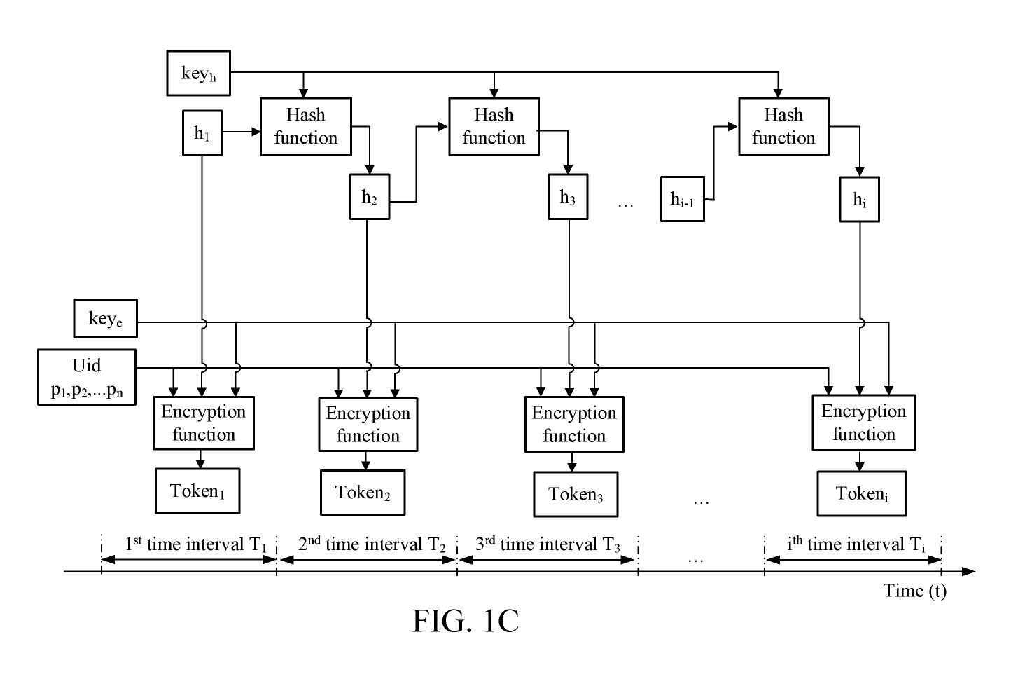

Please refer to FIG. 1A to FIG. 1C for a first embodiment of the present invention. FIG. 1A is a schematic view of an authorization server 1 of the present invention. FIG. 1B depicts signal transmission between the authorization server 1 and a user device 3. FIG. 1C depicts a way of generating an access token according to the present invention. The user device 3 may be a personal computer, a notebook computer, a tablet computer, a smart phone or any electronic device capable of communicating with the authorization server 1 to accomplish an Application Programming Interface (API) authorization program.

The authorization server 1 comprises a memory 11, a processor 13 and a network interface 15. The authorization server 1 may adopts an Open Authorization Standard Version 2.0 (OAuth 2.0) authorization protocol or any protocol extending based on the Hypertext Transfer Protocol Secure (HTTPS), but it is not limited thereto. The processor 13 is electrically connected to the memory 11 and the network interface 15. The memory 11 stores a first key keyₕ and a second key keyₑ. The network interface 15 may be a wired network interface, a wireless network interface and/or a combination thereof, and it is connected to a network (e.g., the internet, a local area network, a telecommunication network or any combination thereof).

A user may operate to connect the user device 3 to the authorization server 1 for registration so as to apply for and obtain a user ID and a permission value corresponding to the user ID. Thereafter, the authorization server 1 records the user ID and the permission value corresponding to the user ID into a user database. The user database may be stored into a storage (not shown) of the authorization server. The storage may be a hard disk or a network storage device accessible via the network interface 11. The user ID may be an account name, and the permission value represents the service type or the service level that can be obtained by the user.

When the user intends to log into the authorization server 1, the user device 3 will transmit an authorization request message 102 carrying a user identification (ID) of the user device 3. After the authorization request message 102 is received from the user device 3 via the network interface 15, the processor 13 generates an access token according to the user ID, the permission value corresponding to the user ID and a hash value, and provides the access token to the user device 3. The processor 13 can read the permission value corresponding to the user ID from the user database based on the user ID carried in the authorization request message 102. The way of generating the access token according to the present invention will be described with reference to FIG. 1C hereinafter.

At the beginning of the operation of the authorization server 1, the processor 13 generates an initial hash value h₁ from random numbers for use in a 1^{st} time interval T₁ to generate an access token. Next, the processor 13 calculates a hash value h₂ for use in a 2^{nd} time interval T₂ from the first key keyₕ and the hash value h₁ according to a one-way encryption hash function. Similarly, for the subsequent i^{th} time interval, the processor 13 calculates an i^{th} hash value hᵢ from the first key keyₕ and an (i−1)^{th} hash value hᵢ₋₁ according to a hash function. For example, the processor 13 calculates a hash value h₃ for use in a 3^{rd} time interval T₃ from the first key keyₕ and the hash value h₂ according to a hash function. In other words, i corresponds to the i^{th} time interval, and the i^{th} hash value hᵢ is for use in the i^{th} time interval to generate an access token Tokenᵢ.

It shall be appreciated that, the length of the time intervals may be set depending on practical operation requirements of the authorization server 1 (e.g., may be 30 minutes, 1 hour, 3 hours, 1 day, 3 months or the like), and these time intervals may be the same as each other or different from each other, i.e., the authorization server 1 may periodically or aperiodically generate a new hash value (update the hash value) and enter into a new time interval after generating a new hash value. Moreover, the authorization server 1 may also generate hash values required in several future time intervals in advance and use these hash values in corresponding time intervals. As shall be appreciated by people skilled in this field, system administrators may set the update frequency of the hash values in consideration of security, so the length of the time intervals and time points to update the hash values are not intended to limit the scope of the present invention.

In the i^{th} time interval, the processor 13 generates the i^{th} access token Tokenᵢ by encrypting a user ID Uid, permission values p₁, p₂, p₃, . . . , pₙ corresponding to the user ID, and the i^{th} hash value hᵢ with the second key keyₑ according to an encryption function after the authorization request message 102 is received from the user device 3 via the network interface 15. Then, the processor 13 generates and transmits an authorization response message 104 carrying the i^{th} access token Tokenᵢ to the user device 3. In this way, the user device 3 can use the i^{th} access token Tokenᵢ to obtain desired resources and services. For example, when the time point at which the user device 3 transmits the authorization request message 102 to the authorization server 1 is within the 2^{nd} time interval T₂, the authorization server 1 generates a 2^{nd} access token Token₂ by encrypting the 2^{nd} hash value h₂, the user ID Uid and the corresponding permission values p₁, p₂, p₃, . . . , pₙ with the second key keyₑ. Thereafter, the authorization server 1 transmits the 2^{nd} access token Token₂ to the user device 3 via the authorization response message 104. It shall be appreciated that, the second key keyₑ is a symmetric key in this embodiment. The authorization server 1 can encrypt/decrypt the access tokens with the second key keyₑ according to a symmetric key encryption algorithm (e.g., 3DES/AES encryption algorithms or the like).

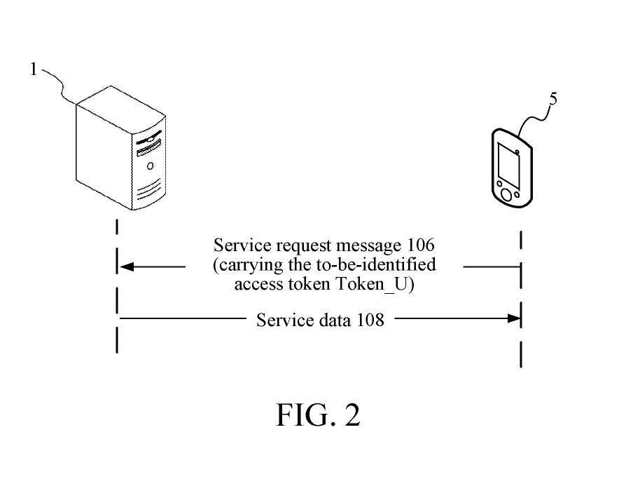

Please refer to FIG. 2 for a second embodiment of the present invention. FIG. 2 depicts signal transmission between the authorization server 1 and another user device 5. Similarly, the user device 5 may be a personal computer, a notebook computer, a tablet computer, a smart phone or any electronic device capable of communicating with the authorization server 1 to accomplish the Application Programming Interface (API) authorization program. In some situations, the user device 5 is the user device 3 of the first embodiment.

After the processor 13 receives a service request message 106 carrying a to-be-identified access token Token_U from the user device 5 via the network interface 15, the processor 13 retrieves the to-be-identified access token Token_U from the service request message 106. Thereafter, the processor 13 uses the second key keyₑ to attempt to decrypt the to-be-identified access token Token_U. If the processor 13 can use the second key keyₑ to correctly decrypt the to-be-identified access token Token_U, then it means that the to-be-identified access token Token_U may be valid, and a hash value h_U, a user ID Uid and the corresponding permission values p₁, p₂, p₃, . . . , pₙ can be obtained by decrypting the to-be-identified access token Token_U. On the contrary, if the to-be-identified access token Token_U cannot be decrypted with the second key keyₑ, then it means that the to-be-identified access token Token_U is invalid. Thus, the processor 13 transmits an authorization failure message (not shown) to the user device 5 via the network interface 15 so as to request the user device 5 to re-obtain an legal access token from the authorization server 1.

After the to-be-identified access token Token_U is correctly decrypted, the processor 13 determines which time interval does the current time lie in (i.e., the i^{th} time interval Tᵢ), and determines whether the hash value h_U is equal to the i^{th} hash value hᵢ based on the hash value corresponding to the current time interval (i.e., the i^{th} hash value hᵢ). When the hash value h_U is equal to the i^{th} hash value hᵢ, the processor 13 determines that the to-be-identified access token Token_U is valid and the user device 5 is in the valid state and provides service data 108 to the user device 5. It shall be appreciated that, the service data may be stored into the aforesaid storage which may be a hard disk or a network storage device accessible via the network interface 11.

Similarly, when the hash value h_U is not equal to the i^{th} hash value hᵢ, the processor 13 transmits an authorization failure message (not shown) to the user device 5 via the network interface 15 so as to request the user device 5 to re-obtain an legal access token from the authorization server 1. It shall be appreciated that, in other embodiments, the processor 13 may further determine whether the user ID Uid and the corresponding permission values p₁, p₂, p₃, . . . , pₙ are consistent with the data stored in the user database and whether they are permitted to request the service data 108 after it is determined that the hash value h_U is equal to the i^{th} hash value hᵢ. Only if the user ID and the corresponding permission values are consistent with the data and are permitted to request the service data 108, does the processor 13 determine that the to-be-identified access token Token_U is valid and provide the service data 108 to the user device 5.

For example, in the 2^{nd} time interval T₂, processor 13 uses the second key keyₑ to attempt to decrypt an access token token₂ after the service request message 106 carrying the access token token₂ is received from the user device 5. If the access token can be decrypted correctly, then the processor 13 can obtain the 2^{nd} hash value h₂, the user ID Uid and the corresponding permission values p₁, p₂, p₃, . . . , pₙ. Thereafter, the processor 13 determines whether the 2^{nd} hash value h₂ obtained by decrypting the access token is the same as the 2^{nd} hash value h₂ used in the current time interval. If they are the same, then it is determined that the user device 5 is in the valid state (in this situation, the user device 5 should be the user device 3 of the first embodiment), and the service data is provided to the user device 5 according to the user ID Uid and the corresponding permission values p₁, p₂, p₃, . . . pₙ.

Please still refer to FIG. 2 for a third embodiment of the present invention which is an extension of the second embodiment. In this embodiment, in order to accelerate the authorization speed of the API and decrease the case where the legal user needs to be re-authorized because he/she has not updated the access token to the authorization server 1 for a long time, the memory 11 further stores a (i−1)^{th} hash value hᵢ₋₁ to a (i−x)^{th} hash value hᵢ₋ₓ, and wherein x is a positive integer and i−x is also a positive integer. The value of x may be set depending on practical operation requirements of the authorization server 1, and it represents a tolerance value of the time interval.

After it is determined that the hash value h_U obtained by decrypting the access token Token_U is not the same as the i^{th} hash value hᵢ of the current time interval Tᵢ, the processor 13 may further determine whether the hash value h_U is one of the (i−1)^{th} hash value hᵢ₋₁ to the (i−x)^{th} hash value hᵢ₋ₓ. When the hash value h_U is one of the (i−1)^{th} hash value hᵢ₋₁ to the (i−x)^{th} hash value hᵢ₋ₓ, the processor 13 determines that the access token Token_U is valid and the user device 5 is in the valid state and provides the service data 108 to the user device 5. Similarly, when the hash value h_U is not equal to one of the (i−1)^{th} hash value hᵢ₋₁ to the (i−x)^{th} hash value hᵢ₋ₓ, the processor 13 transmits an authorization failure message (not shown) to the user device 5 via the network interface 15 so as to request the user device 5 to re-obtain an legal access token from the authorization server 1.

For example, in the case where x is 1 (which means that the previous time interval can be accepted) and when the hash value h_U is the 2^{nd} hash value h₂ and the current time is within the 3^{rd} time interval T₃, the processor 13 further determines whether the hash value h_U is the 2^{nd} hash value h₂ of the previous time interval (i.e., the 2^{nd} time interval T₂) after determining that the hash value h_U is not equal to the 3^{rd} hash value h₃. If the hash value h_U is equal to the 2^{nd} hash value h₂, then the processor 13 can determine that the access token Token_U is valid and the user device 5 is in the valid state and then provide the service data 108 to the user device 5 according to the user ID Uid and the corresponding permission values p₁, p₂, p₃, . . . , pₙ.

Additionally, the processor 13 may further transmit a new access token (i.e., the access token Tokenᵢ of the current time interval Tᵢ) to the user device 5 after determining that the access token Token_U is valid and the user device 5 is in the valid state. In this way, the user device 5 can update the access token thereof for later use to request other services.

Please still refer to FIG. 2 for a fourth embodiment of the present invention which is an extension of the second embodiment. In this embodiment, in order to trace to determine the legality of the service request message 106 so as to block malicious users, the processor further stores the 1^{st} hash value h₁ to the (i−1)^{th} hash value hᵢ₋₁ into a storage (not shown). Therefore, when the hash value h_U is not equal to the i^{th} hash value hᵢ, the processor 13 further determines whether the hash value h_U is equal to one of the 1^{st} hash value h₁ to the (i−1)^{th} hash value hᵢ₋₁.

In detail, the memory 11 may further store a blacklist in which the blocked Internet Protocol Address (IP address) is recorded so that the authorization server 1 can block malicious users. After it is determined that the hash value h_U obtained by decrypting the access token Token_U is not the same as the i^{th} hash value hᵢ of the current time interval Tᵢ, the processor 13 further determines whether the hash value h_U has not appeared in a historical hash value list (i.e., the 1^{st} hash value h₁ to the (i−1)^{th} hash value hᵢ₋₁). If the hash value h_U has not appeared in the historical hash value list, then the processor 13 determines that the user device 5 who transmits the service request message 106 is a malicious user and adds connection information (i.e., the IP address) of the user device 5 into the blacklist. In this way, the authorization server 1 can filter received packets according to the IP address recorded in the blacklist, thereby preventing the system from breaking down due to malicious attacks.

Moreover, in other embodiments, the authorization server 1 may provide or store the blacklist into a firewall device or a router device so that these malicious packets are filtered out at the front-end device and thus will not be received by the authorization server 1. Additionally, in other embodiments, the authorization server 1 may not need to store the historical hash value list (i.e., not need to store the 1^{st} hash value h₁ to the (i−1)^{th} hash value hᵢ₋₁), the processor 13 may calculate a 2^{nd} hash value h₂ from the first key keyₕ and the 1^{st} hash value h₁ according to the hash function, calculate a 3^{rd} hash value h₃ from the first key keyₕ and the 2^{nd} hash value h₂ according to the hash function, and calculate a 4^{th} hash value h₄ to a (i−1)^{th} hash value hᵢ₋₁ sequentially in the same manner; and each time an old hash value is obtained, the processor 13 determines whether the hash value h_U is the same as the old hash value.

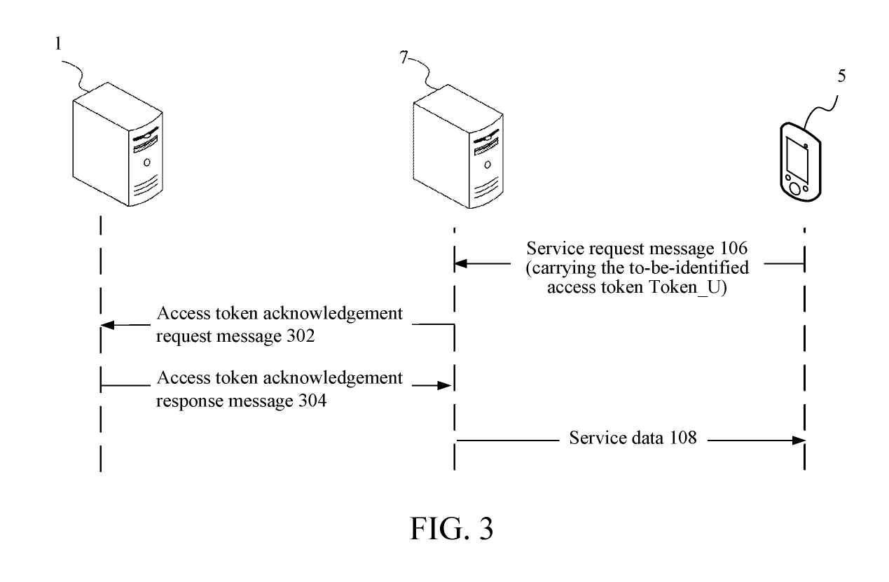

Please refer to FIG. 3 for a fifth embodiment of the present invention. FIG. 3 depicts signal transmission among the authorization server 1, a service resource server 7 and the user device 5. The service resource server 7 and the authorization server 1 are usually set by a same service provider. If the user wants to obtain service from the service resource server 7, he/she needs to first obtain an access token from the authorization server 1 so as to use the access token to obtain the service from the service resource server 7. In other words, in this embodiment, the authorization server 1 may cooperate with the service resource server 7, and the service resource server 7 transmits the access token to the authorization server 1 for authorization after receiving the service request message 106 from the user device 5.

Specifically, as shown in FIG. 3, the user device 5 transmits the service request message 106 carrying a to-be-identified access token Token_U to the service resource server 7. Thereafter, the service resource server 7 transmits an access token acknowledgement message 302 carrying the to-be-identified access token Token_U to the authorization server 1. After the access token acknowledgement message 302 is received from the service resource server 7 via the network interface 15, the processor 13 retrieves the to-be-identified access token Token_U from the access token acknowledgement message 302.

Next, the processor 13 uses the second key keyₑ to attempt to decrypt the to-be-identified access token Token_U. If the processor 13 can use the second key keyₑ to correctly decrypt the to-be-identified access token Token_U, then it means that the to-be-identified access token Token_U may be valid, and a hash value h_U, a user ID Uid and the corresponding permission values p₁, p₂, p₃, . . . , pₙ can be obtained by decrypting the to-be-identified access token Token_U. On the contrary, if the to-be-identified access token Token_U cannot be decrypted with the second key keyₑ, then it means that the to-be-identified access token Token_U is invalid, and thus the processor 13 transmits an access token invalid message (not shown) to the service resource server 7 via the network interface 15. In this way, the service resource server 7 can transmit an authorization failure message (not shown) to the user device 5 so as to request the user device 5 to re-obtain an legal access token from the authorization server 1.

After the to-be-identified access token Token_U is correctly decrypted, the processor 13 determines which time interval does the current time lie in (i.e., the i^{th} time interval Tᵢ), and determines whether the hash value h_U is equal to the i^{th} hash value hᵢ based on the hash value corresponding to the current time interval (i.e., the i^{th} hash value hᵢ). When the hash value h_U is equal to the i^{th} hash value hᵢ, the processor 13 determines that the to-be-identified access token Token_U is valid and the user device 5 is in a valid state and provides an access token acknowledgement response message 304 to the service resource server 7. In this way, the service resource server 7 provides the service data 108 to the user device 5 in response to the access token acknowledgement response message 304. In this embodiment, the service data 108 may be stored into the service resource server 7 or a network storage device connected with the service resource server 7.

Similarly, when the hash value h_U is not equal to the i^{th} hash value hᵢ, the processor 13 transmits an access token invalid message (not shown) to the service resource server 7 via the network interface 15. In this way, the service resource server 7 can transmit an authorization failure message (not shown) to the user device 5 so as to request the user device 5 to re-obtain an legal access token from the authorization server 1. It shall be appreciated that, in other embodiments, the processor 13 may further determine whether the user ID Uid and the corresponding permission values p₁, p₂, p₃, . . . , pₙ are consistent with the data stored in the user database and whether they are permitted to request the service data 108 after it is determined that the hash value h_U is equal to the i^{th} hash value hᵢ. Only if the user ID and the corresponding permission values are consistent with the data and are permitted to request the service data 108, does the processor 13 determine that the to-be-identified access token Token_U is valid.

Please refer to FIG. 3 for a sixth embodiment of the present invention which is an extension of the fifth embodiment. Like the third embodiment, in order to accelerate the authorization speed of the API and decrease the case where the legal user needs to be re-authorized because he/she has not updated the access token to the authorization server 1 for a long time, the memory 11 further stores the (i−1)^{th} hash value hᵢ₋₁ to the (i−x)^{th} hash value hᵢ₋ₓ in this embodiment, and wherein x is a positive integer and i−x is also a positive integer. The value of x may be set depending on practical operation requirements of the authorization server 1, and it represents a tolerance value of the time interval.

Thus, after it is determined that the hash value h_U obtained by decrypting the access token Token_U is not the same as the i^{th} hash value hᵢ of the current time interval Tᵢ, the processor 13 may further determine whether the hash value h_U is one of the (i−1)^{th} hash value hᵢ₋₁ to the (i−x)^{th} hash value hᵢ₋ₓ. When the hash value h_U is one of the (i−1)^{th} hash value hᵢ₋₁ to the (i−x)^{th} hash value hᵢ₋ₓ, the processor 13 determines that the access token Token_U is valid and the user device 5 is in the valid state. Thereafter, the processor 13 generates an access token acknowledgement response message 304 and transmits the access token acknowledgement response message 304 to the service resource server 7 via the network interface 15 so that the service resource server 7 provides the service data 108 to the user device 5.

Similarly, when the hash value h_U is not equal to one of the (i−1)^{th} hash value hᵢ₋₁ to the (i−x)^{th} hash value hᵢ₋ₓ, the processor 13 transmits an access token invalid message (not shown) to the service resource server 7 via the network interface 15. In this way, the service resource server 7 can transmit an authorization failure message (not shown) to the user device 5 so as to request the user device 5 to re-obtain an legal access token from the authorization server 1.

Please still refer to FIG. 3 for a seventh embodiment of the present invention which is an extension of the fifth embodiment. Like the fourth embodiment, in order to trace to determine the legality of the service request message 106 so as to block malicious users, the processor further stores the 1^{st} hash value hᵢ to the (i−1)^{th} hash value hᵢ₋₁ into a storage (not shown) in this embodiment. Therefore, when the hash value h_U is not equal to the i^{th} hash value hᵢ, the processor 13 further determines whether the hash value h_U is equal to one of the 1^{st} hash value h₁ to the (i−1)^{th} hash value hᵢ₋₁.

In detail, after it is determined that the hash value h_U obtained by decrypting the access token Token_U is not the same as the i^{th} hash value hᵢ of the current time interval Tᵢ, the processor 13 further determines whether the hash value h_U has not appeared in the historical hash value list. If the hash value h_U has not appeared in the historical hash value list, then the processor 13 determines that the user device 5 who transmits the service request message 106 is a malicious user and adds connection information (i.e., the IP address) of the user device 5 into the blacklist. The blacklist may be stored into the service resource server 7 so as to allow the service resource server 7 to filter received packets according to the IP address recorded in the blacklist, thereby preventing the system from breaking down due to malicious attacks. Similarly, in other embodiments, the authorization server 1 may provide or store the blacklist into a firewall device or a router device so that these malicious packets are filtered out at the front-end device and thus will not be received by the service resource server 7.

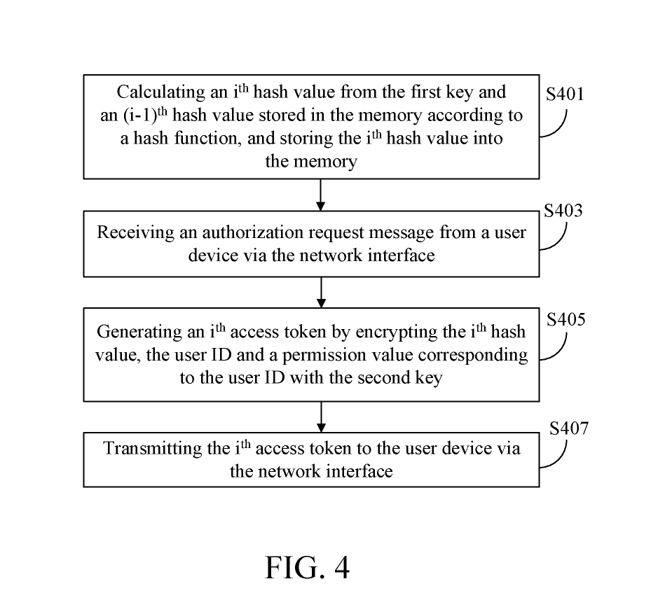

An eighth embodiment of the present invention is as shown in FIG. 4, which is a flowchart diagram of an authorization method. The authorization method is for use in an authorization server (e.g., the authorization server 1 of the aforesaid embodiments). The authorization server comprises a memory, a network interface and a processor. The memory stores a first key and a second key. The processor is electrically connected to the memory and the network interface. The authorization method of the present invention is executed by the processor.

First, in step S401, an i^{th} hash value is calculated from the first key and an (i−1)^{th} hash value stored in the memory according to a hash function, and the i^{th} hash value is stored into the memory. As described above, i corresponds to an i^{th} time interval and is a positive integer larger than 2. Next, in step S403, an authorization request message is received from a user device via the network interface. Thereafter, in step S405, an i^{th} access token is generated by encrypting the i^{th} hash value, the user ID and a permission value corresponding to the user ID with the second key. Then, in step S407, the i^{th} access token is transmitted to the user device via the network interface.

Furthermore, in another embodiment, the authorization method of the present invention further comprises following steps of: receiving a service request message carrying a to-be-identified access token from another user device via the network interface; obtaining a hash value by decrypting the to-be-identified access token with the second key; and when the hash value is equal to the i^{th} hash value, determining that the another user device is in a valid state and provides service data to the another user device.

Moreover, in another embodiment, the authorization method of the present invention may further comprise the following steps when the memory further stores the (i−1)^{th} hash value to an (i−x)^{th} hash value (where x is a positive integer and i−x is also a positive integer): when the hash value is not equal to the i^{th} hash value, determining whether the hash value is equal to one of the (i−1)^{th} hash value to the (i−x)^{th} hash value; and when the hash value is equal to one of the (i−1)^{th} hash value to the (i−x)^{th} hash value, determining that the another user device is in the valid state and provides the service data to the another user device.

Furthermore, in another embodiment, the authorization method of the present invention further comprises the following steps when a storage of the authorization server further stores a 1^{st} hash value to the (i−1)^{th} hash value: when the hash value is not equal to the i^{th} hash value, determining whether the hash value is equal to one of the 1^{st} hash value to the (i−1)^{th} hash value; and when the hash value is not equal to one of the 1^{st} hash value to the (i−1)^{th} hash value, adding connection information of the another user device into a blacklist.

Moreover, in another embodiment, the authorization method of the present invention further comprises the following steps when the authorization server connects to a service resource server and the service resource server receives a service request message carrying a to-be-identified access token from another user device: receiving an access token acknowledgement message carrying the to-be-identified access token from the service resource server; obtaining a hash value by decrypting the to-be-identified access token with the second key; and when the hash value is equal to the i^{th} hash value, determining that the another user device is in a valid state and transmitting an access token acknowledgement response message to the service resource server via the network interface so that the service resource server provides service data to the another user device.

Moreover, in another embodiment, the authorization method of the present invention may further comprise the following steps when the memory further stores the (i−1)^{th} hash value to an (i−x)^{th} hash value (where x is a positive integer and i−x is also a positive integer): when the hash value is not equal to the i^{th} hash value, determining whether the hash value is equal to one of the (i−1)^{th} hash value to the (i−x)^{th} hash value; and when the hash value is equal to one of the (i−1)^{th} hash value to the (i−x)^{th} hash value, determining that the another user device is in the valid state and transmitting the access token acknowledgement response message to the service resource server via the network interface so that the service resource server provides the service data to the another user device.

Furthermore, in another embodiment, the authorization method of the present invention further comprises the following steps when a storage of the authorization server further stores a 1^{st} hash value to the (i−1)^{th} hash value: when the hash value is not equal to the i^{th} hash value, determining whether the hash value is equal to one of the 1^{st} hash value to the (i−1)^{th} hash value; and when the hash value is not equal to one of the 1^{st} hash value to the (i−1)^{th} hash value, adding connection information of the another user device into a blacklist.

In addition to the aforesaid steps, the authorization method of the present invention can also execute all the operations and steps of the authorization server set forth in all the aforesaid embodiments, have the same functions and deliver the same technical effects. How the authorization method of the present invention executes these operations and steps, has the same functions and delivers the same technical effects will be readily appreciated by people skilled in this field based on the explanation of all the aforesaid embodiments, and thus will not be further described herein.

Additionally, the authorization method of the present invention may be accomplished by a non-transitory computer readable medium. The non-transitory computer readable medium stores a computer program comprising a plurality of codes, and after the computer program is loaded and installed into an electronic computing device (e.g., the authorization server 1), the codes comprised in the computer program are executed by the processor of the electronic computing device to accomplish the authorization method of the present invention. The non-transitory computer readable medium may be for example a read only memory (ROM), a flash memory, a floppy disk, a hard disk, a compact disk (CD), a mobile disk, a magnetic tape, a database accessible to networks, or any other storage media with the same function and well known to people skilled in this field.

According to the above descriptions, the authorization mechanism of the present invention generates a particular hash value related to a time interval as one of authorization data according to the irreversibility of a one-way hash function, and generates an access token by encrypting the particular hash value corresponding to the current time interval, the user ID and the user permission value. Moreover, the authorization mechanism of the present invention connects the hash values respectively corresponding to each of the time intervals based on the positive correlation of the hash function, so the authorization mechanism can trace to determine the legality of the access token to block the malicious users. Therefore, as compared to the prior art, the authorization mechanism of the present invention does not need to store the access tokens of the users for later authorization and is capable of tracing to determine the legality of the packet by decrypting the access tokens to obtain particular hash values associated with the time intervals.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An authorization server, comprising:
a memory, being configured to store a first key and a second key;
a network interface;
a processor electrically connected to the memory and the network interface, being configured to calculate an i^{th} hash value from the first key and an (i−1)^{th} hash value stored in the memory according to a hash function and store the i^{th} hash value into the memory, wherein i corresponds to an i^{th} time interval and is a positive integer larger than 2;
wherein the processor is further configured to execute the following operations:
receiving an authorization request message carrying a user identification (ID) of a user device from the user device via the network interface;
generating an i^{th} access token by encrypting the i^{th} hash value, the user ID and a permission value corresponding to the user ID with the second key; and
transmitting an authorization response message carrying the i^{th} access token to the user device via the network interface.

2. The authorization server of claim 1, wherein the authorization server adopts an Open Authorization Standard Version 2.0 (OAuth 2.0) authorization protocol.

3. The authorization server of claim 1, wherein the processor further receives a service request message carrying a to-be-identified access token from another user device via the network interface, and the processor further obtains a hash value by decrypting the to-be-identified access token with the second key;
wherein when the hash value is equal to the i^{th} hash value, the processor determines that the another user device is in a valid state and provides service data to the another user device.

4. The authorization server of claim 3, wherein the memory further stores the (i−1)^{th} hash value to an (i−x)^{th} hash value, where x is a positive integer and i−x is a positive integer;
wherein when the hash value is not equal to the i^{th} hash value, the processor further determines whether the hash value is equal to one of the (i−1)^{th} hash value to the (i−x)^{th} hash value, and when the hash value is equal to one of the (i−1)^{th} hash value to the (i−x)^{th} hash value, the processor determines that the another user device is in the valid state and provides the service data to the another user device.

5. The authorization server of claim 3, further comprising a storage that stores a 1 hash value to the (i−1)^{th} hash value, wherein when the hash value is not equal to the i^{th} hash value, the processor further determines whether the hash value is equal to one of the 1^{st} hash value to the (i−1)^{th} hash value;
wherein when the hash value is not equal to one of the 1^{st} hash value to the (i−1)^{th} hash value, the processor adds connection information of the another user device into a blacklist.

6. The authorization server of claim 1, wherein the authorization server further connects to a service resource server, the service resource server receives a service request message carrying a to-be-identified access token from another user device and generates an access token acknowledgement message carrying the to-be-identified access token, and the processor further receives the access token acknowledgement message from the resource server and obtains a hash value by decrypting the to-be-identified access token with the second key;
wherein when the hash value is equal to the i^{th} hash value, the processor determines that the another user device is in a valid state and transmits an access token acknowledgement response message to the service resource server via the network interface so that the service resource server provides service data to the another user device.

7. The authorization server of claim 6, wherein the memory further stores the (i−1)^{th} hash value to an (i−x)^{th} hash value, where x is a positive integer and i−x is a positive integer;
wherein when the hash value is not equal to the i^{th} hash value, the processor further determines whether the hash value is equal to one of the (i−1)^{th} hash value to the (i−x)^{th} hash value, and when the hash value is equal to one of the (i−1)^{th} hash value to the (i−x)^{th} hash value, the processor determines that the another user device is in the valid state and transmits the access token acknowledgement response message to the service resource server via the network interface so that the service resource server provides the service data to the another user device.

8. The authorization server of claim 6, further comprising a storage that stores a 1^{st} hash value to the (i−1)^{th} hash value,
wherein when the hash value is not equal to the i^{th} hash value, the processor further determines whether the hash value is equal to one of the 1^{st} hash value to the (i−1)^{th} hash value, and when the hash value is not equal to one of the 1^{st} hash value to the (i−1)^{th} hash value, the processor adds connection information of the another user device into a blacklist.

9. An authorization method for an authorization server, the authorization server comprising a memory, a network interface and a processor, the memory storing a first key and a second key, the authorization method being executed by the processor and comprising:
calculating an i^{th} hash value from the first key and an (i−1)^{th} hash value stored in the memory according to a hash function, and storing the i^{th} hash value into the memory, wherein i corresponds to an i^{th} time interval and is a positive integer larger than 2;
receiving an authorization request message carrying a user identification (ID) of a user device from the user device via the network interface;
generating an i^{th} access token by encrypting the i^{th} hash value, the user ID and a permission value corresponding to the user ID with the second key; and
transmitting the i^{th} access token to the user device via the network interface.

10. The authorization method of claim 9, wherein the authorization method adopts an Open Authorization Standard Version 2.0 (OAuth 2.0) authorization protocol.

11. The authorization method of claim 9, further comprising:
receiving a service request message carrying a to-be-identified access token from another user device via the network interface;
obtaining a hash value by decrypting the to-be-identified access token with the second key; and
when the hash value is equal to the i^{th} hash value, determining that the another user device is in a valid state and provides service data to the another user device.

12. The authorization method of claim 11, wherein the memory further stores the (i−1)^{th} hash value to an (i−x)^{th} hash value, where x is a positive integer and i−x is a positive integer, and the authorization method further comprising:
when the hash value is not equal to the i^{th} hash value, determining whether the hash value is equal to one of the (i−1)^{th} hash value to the (i−x)^{th} hash value; and
when the hash value is equal to one of the (i−1)^{th} hash value to the (i−x)^{th} hash value, determining that the another user device is in the valid state and provides the service data to the another user device.

13. The authorization method of claim 11, wherein the authorization server further comprises a storage that stores a 1^{st} hash value to the (i−1)^{th} hash value, and the authorization method further comprising:
when the hash value is not equal to the i^{th} hash value, determining whether the hash value is equal to one of the 1^{st} hash value to the (i−1)^{th} hash value; and
when the hash value is not equal to one of the 1^{st} hash value to the (i−1)^{th} hash value, adding connection information of the another user device into a blacklist.

14. The authorization method of claim 9, wherein the authorization server further connects to a service resource server, the service resource server receives a service request message carrying a to-be-identified access token from another user device and generates an access token acknowledgement message carrying the to-be-identified access token, and the authorization method further comprising:
receiving the access token acknowledgement message from the service resource server; and
obtaining a hash value by decrypting the to-be-identified access token with the second key; and
when the hash value is equal to the i^{th} hash value, determining that the another user device is in a valid state and transmitting an access token acknowledgement response message to the service resource server via the network interface so that the service resource server provides service data to the another user device.

15. The authorization method of claim 14, wherein the memory further stores the (i−1)^{th} hash value to an (i−x)^{th} hash value, where x is a positive integer and i−x is a positive integer, and the authorization method further comprising:
when the hash value is not equal to the i^{th} hash value, determining whether the hash value is equal to one of the (i−1)^{th} hash value to the (i−x)^{th} hash value; and
when the hash value is equal to one of the (i−1)^{th} hash value to the (i−x)^{th} hash value, determining that the another user device is in the valid state and transmitting the access token acknowledgement response message to the service resource server via the network interface so that the service resource server provides the service data to the another user device.

16. The authorization method of claim 14, wherein the authorization server further comprises a storage that stores a 1^{st} hash value to the (i−1)^{th} hash value, and the authorization method further comprising:
when the hash value is not equal to the i^{th} hash value, determining whether the hash value is equal to one of the 1^{st} hash value to the (i−1)^{th} hash value; and
when the hash value is not equal to one of the 1^{st} hash value to the (i−1)^{th} hash value, adding connection information of the another user device into a blacklist.

17. A non-transitory computer readable medium storing a computer program comprising a plurality of codes, wherein when the computer program is loaded into an authorization server having a processor, the codes are executed by the processor to accomplish an authorization method, the authorization server comprises a memory, a network interface and the processor, and the memory stores a first key and a second key, the authorization method comprising:
calculating an i^{th} hash value from the first key and an (i−1)^{th} hash value stored in the memory according to a hash function, and storing the i^{th} hash value into the memory, wherein i corresponds to an i^{th} time interval and is a positive integer larger than 2;
receiving an authorization request message carrying a user identification (ID) of a user device from the user device via the network interface;
generating an i^{th} access token by encrypting the i^{th} hash value, the user ID and a permission value corresponding to the user ID with the second key; and
transmitting the i^{th} access token to the user device via the network interface.
